(19) United States
(12) Patent Application Publication
(10) Pub. No.: US 2015/0153494 A1
(43) Pub. Date: Jun. 4, 2015

(54) COMPOSITE OPTICAL SHEET AND BACKLIGHT UNIT INCLUDING THE SAME

(71) Applicant: SAMSUNG SDI CO., LTD., Yongin-si (KR)

(72) Inventors: Jin Woo KIM, Suwon-si (KR); Kyoung Ku KANG, Suwon-si (KR)

(21) Appl. No.: 14/518,738

(22) Filed: Oct. 20, 2014

(30) Foreign Application Priority Data
Nov. 29, 2013 (KR) 10-2013-0147952

(51) Int. Cl. G02B 5/30; F21V 8/00; F21V 9/14; G02B 5/04; G02B 3/00

(52) U.S. Cl. CPC G02B 5/305; G02B 5/045; G02B 3/0006; F21V 9/14; G02B 6/0056

(57) ABSTRACT

A composite optical sheet and a backlight unit, the composite optical sheet including a first optical sheet that includes a first optical pattern; a second optical sheet that includes a second optical pattern; a first adhesive layer between the first optical sheet and the second optical sheet; and a reflective polarizing film, wherein the second optical pattern is adhered to the first adhesive layer, the reflective polarizing film has a plurality of polymer layers that have different indexes of refraction, the plurality of polymer layers being alternately stacked one above another, and the reflective polarizing film is integrated with the first optical sheet, the second optical sheet, or the first adhesive layer.

### CROSS-REFERENCE TO RELATED APPLICATION

Korean Patent Application No. 10-2013-0147952, filed on Nov. 29, 2013, in the Korean Intellectual Property Office, and entitled: “Composite Optical Sheet and Backlight Unit Including the Same,” is incorporated by reference herein in its entirety.

### BACKGROUND

1. Field

Embodiments relate to a composite optical sheet and a backlight unit including the same.

2. Description of the Related Art

Liquid crystal displays are one of the most widely used flat panel displays. Liquid crystal displays may have a structure in which a liquid crystal layer is enclosed between a TFT array substrate and a color filter substrate. When an electric field is applied to electrodes on the TFT array substrate and color filter substrate, arrangement of liquid crystal molecules in the liquid crystal layer therebetween may be changed, thereby enabling display of images.

Liquid crystal displays are not self-luminous and thus require a backlight unit as a light source. The backlight unit may include a light source (e.g., a light emitting diode or fluorescent lamp), a light guide plate, a prism sheet, a diffusive sheet, and a protective sheet.

### SUMMARY

Embodiments are directed to a composite optical sheet and a backlight unit including the same.

The embodiments may be realized by providing a composite optical sheet, including a first optical sheet that includes a first optical pattern; a second optical sheet that includes a second optical pattern; a first adhesive layer between the first optical sheet and the second optical sheet; and a reflective polarizing film, wherein the second optical pattern is adhered to the first adhesive layer, the reflective polarizing film has a plurality of polymer layers that have different indexes of refraction, the plurality of polymer layers being alternately stacked one above another, and the reflective polarizing film is integrated with the first optical sheet, the second optical sheet, or the first adhesive layer.

The first optical sheet may include a first base film and the first optical pattern, the reflective polarizing film may be between the first adhesive layer and the first base film, and the first base film and the reflective polarizing film may be integrated with each other via a second adhesive layer.

The first base film may include a non-oriented or uniaxially oriented polycarbonate film or a non-oriented or uniaxially oriented polyethylene terephthalate film.

The first optical sheet may include a first base film and the first optical pattern, the reflective polarizing film may be between the first base film and the first optical pattern, and the first base film and the reflective polarizing film may be integrated with each other via a second adhesive layer.

The second optical sheet may include a second base film and the second optical pattern, the reflective polarizing film may be between the second base film and the second optical pattern, and the second base film and the reflective polarizing film may be integrated with each other via a second adhesive layer.

The second optical sheet may include a second base film and the second optical pattern, the reflective polarizing film may be under the second base film, and the second base film and the reflective polarizing film may be integrated with each other via a second adhesive layer.

The second base film may include a non-oriented or uniaxially oriented polycarbonate film or a non-oriented or uniaxially oriented polyethylene terephthalate film.

The reflective polarizing film may be on the first optical pattern, and the first optical pattern and the reflective polarizing film may be integrated with each other via a second adhesive layer.

The reflective polarizing film may include first and second polymer layers alternately stacked one above another, the first polymer layer may have a thickness of about 15 μm to about 25 μm and an index of refraction of about 1.45 to about 1.49, and the second polymer layer may have a thickness of about 15 μm to about 25 μm and an index of refraction of about 1.51 to about 1.58.

The first and second optical patterns may each independently include patterns selected from the group of a microlens pattern, a hexagonal microlens pattern, an embossed pattern, a lenticular lens pattern, a prism pattern, a pyramidal pattern, and combinations thereof.

At least one of the first optical pattern and the second optical pattern may include the prism pattern, and the prism pattern may include a plurality of prisms, apexes of which adjoin or penetrate the first adhesive layer.

The prisms may have a height of about 10 μm to about 50 μm and a pitch of about 20 μm to about 100 μm.

The first optical pattern and the second optical pattern may be prism patterns.

The first optical pattern may be a lenticular lens pattern and the second optical pattern is a prism pattern.

The first optical sheet may have a thickness of about 50 μm to about 300 μm, the second optical sheet may have a thickness of about 50 μm to about 300 μm, the first adhesive layer may have a thickness of about 1 μm to about 30 μm, and the reflective polarizing film may have a thickness of about 120 μm to about 150 μm.

The embodiments may be realized by providing a backlight unit comprising the composite optical sheet according to an embodiment.

### BRIEF DESCRIPTION OF THE DRAWINGS

Features will be apparent to those of skill in the art by describing in detail exemplary embodiments with reference to the attached drawings in which:

FIG. 1(a) illustrates a perspective view of a composite optical sheet according to a first embodiment, FIG. 1(b) illustrates a sectional view of the composite optical sheet taken along line a-a′ of FIG. 1(a), and FIG. 1(c) illustrates a sectional view of the composite optical sheet further comprising the second adhesive layer;

FIG. 2 illustrates a perspective view of a composite optical sheet according to another embodiment;

FIG. 3 illustrates an exploded perspective view of a composite optical sheet showing a position in which a reflective polarizing film is arranged;

FIG. 4(a) illustrates a sectional view of a composite optical sheet according to a second embodiment, and FIG. 4(b) illustrates a sectional view of a composite optical sheet according to a second embodiment that further comprising the second adhesive layer;

FIG. 5(a) illustrates a sectional view of a composite optical sheet according to a third embodiment, and FIG. 5(b) illustrates a sectional view of a composite optical sheet according to a third embodiment that further comprising the second adhesive layer;

FIG. 6(a) illustrates a sectional view of a composite optical sheet according to a fourth embodiment, and FIG. 6(b) illustrates a sectional view of a composite optical sheet according to a fourth embodiment that further comprising the second adhesive layer;

FIG. 7(a) illustrates a sectional view of a composite optical sheet according to a fifth embodiment, and FIG. 7(b) illustrates a sectional view of a composite optical sheet according to a fifth embodiment that further comprising the second adhesive layer; and

FIG. 8 illustrates a perspective view of a backlight unit according to one embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It should be noted that all the drawings are described from the viewpoint of the observer. It will be understood that, when an element is referred to as being “on” another element, the element can be directly formed on the other element, or intervening element(s) may also be present therebetween.

As used herein, the terms “upper surface” and “lower surface” are defined based on the drawings, and thus, “upper surface” and “lower surface” may be used interchangeably according to orientation. In addition, it will be understood that, the expression “a certain layer formed on another layer” indicates locations of the layers, and includes not only a structure wherein the layers are directly stacked one above another but also a structure wherein intervening layer(s) are present therebetween.

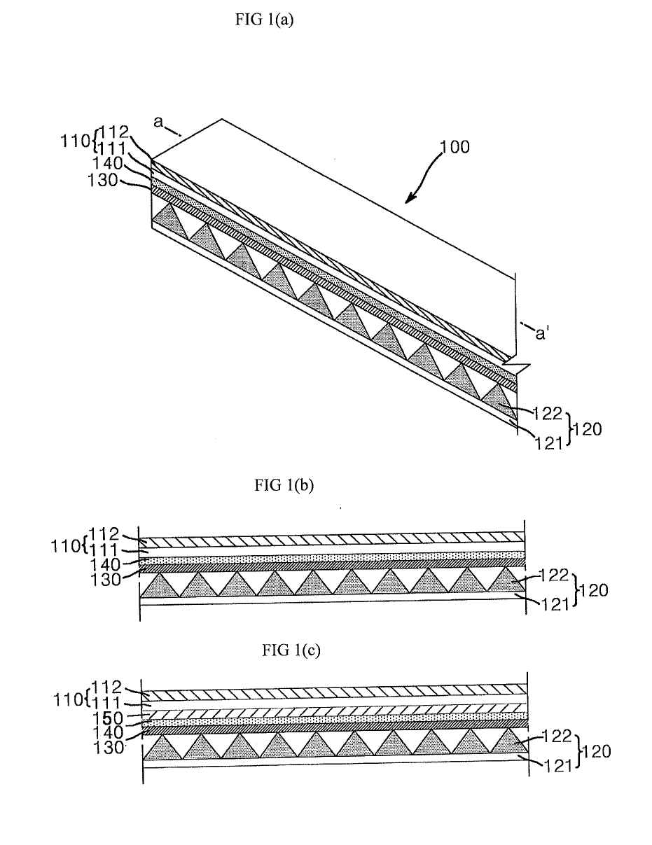

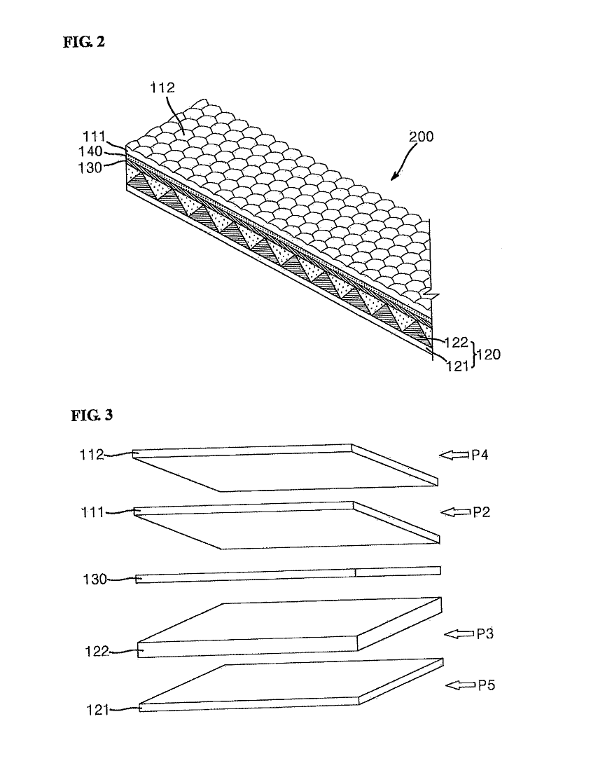

Hereinafter, a composite optical sheet according to a first embodiment will be described in detail with reference to FIGS. 1 and 2. FIG. 1(a) illustrates a perspective view of the composite optical sheet according to the first embodiment, FIG. 1(b) illustrates a sectional view of the composite optical sheet, taken along line a-a′ of FIG. 1(a), and FIG. 1(c) illustrates a sectional view of the composite optical sheet further comprising the second adhesive layer.

Referring to FIG. 1, the composite optical sheet 100 according to the first embodiment may include a first optical sheet 110, a second optical sheet 120, a first adhesive layer 130, and a reflective polarizing film 140.

The first optical sheet 110 may include a first base film 111 and a first optical pattern 112. In FIG. 1, the first optical pattern 112 is shown as being formed on the first base film 111.

The first optical pattern 112 may include, e.g., a microlens pattern, a hexagonal microlens pattern, an embossed pattern, a lenticular lens pattern, a prism pattern, a pyramidal pattern, a matt pattern, or combinations thereof. The first optical pattern 112 may have an index of refraction of about 1.45 to about 1.49. Within this range, the first optical pattern may help improve luminance. For example, the embossed pattern may be composed of irregularly embossed or engraved unevenness, and may be formed by striking a surface of a roll with beads having a diameter of about 1 μm to about 200 μm. The matt pattern may be composed of non-uniform fine unevenness and may be formed by matt-coating. Both the embossed pattern and the matt pattern may diffuse light, thereby helping to improve luminance. FIG. 2 illustrates a composite optical sheet 200 that has a hexagonal microlens pattern as the first optical pattern 112 on the first base film 111.

The second optical sheet 120 may include a second base film 121 and a second optical pattern 122. FIG. 1 illustrates a prism pattern on the second base film 121 as the second optical pattern 122. In an implementation, the second optical pattern 122 may include, e.g., a microlens pattern, a hexagonal microlens pattern, an embossed pattern, a lenticular lens pattern, a pyramidal pattern, or combinations thereof. The second optical pattern 122 may have an index of refraction of about 1.51 to about 1.67, e.g., about 1.51 to about 1.58. Within this range, the second optical pattern may help improve luminance.

The prism pattern may include a plurality of prisms arranged on the second base film 121. The prism pattern may have an isosceles triangular cross-section, as illustrated in FIG. 1. In an implementation, the prism pattern may have other types of cross-sections, e.g., a triangular cross-section, a trapezoid cross-section, or a curved cross-section, such as a circular cross-section, a sinusoidal cross-section, or a parabolic cross-section.

The second optical pattern 122, e.g., the prism pattern, may be an optical member that refracts light that has passed through the second base film 121 such that the light travels in a predetermined direction. The prism pattern may be composed of a plurality of prisms arranged in a row in a same direction. The plurality of prisms may each have a triangular cross-section and may include, e.g., trigonal prisms. The prisms may have, e.g., a height of about 10 μm to about 50 μm and/or a pitch of about 20 μm to about 100 μm. The prisms may have an apex angle of about 30° to about 150°. Within this range, light collecting effect may be maximized, thereby providing excellent luminance.

The first adhesive layer 130 may be formed between the first optical sheet 110 and the second optical sheet 120. The first optical sheet 110 and the second optical sheet 120 may be integrated with (e.g., adhered to) each other via the first adhesive layer 130. For example, the first optical sheet 110 and the second optical sheet 120 may be integrated with (e.g., adhered to) each other by forming the prism pattern of the second optical sheet 120 to adjoin or penetrate into the first adhesive layer 130. As used herein, the term “penetrate” may mean that the apexes of the prisms forming the prism pattern break through and enter the first adhesive layer. As used herein, the term “integrated” refers to two objects that are physically coupled to each other by adhesives or the like.

The reflective polarizing film 140 may be formed on the first adhesive layer 130, e.g., between the first base film 111 and the adhesive layer 130. In an implementation, a second adhesive layer 150 may be formed between the first base film 111 and the reflective polarizing film 140, and may facilitate integration of the base film 111 and the reflective polarizing film 140 with each other therethrough. As used herein, the term “second adhesive layer” may refer to an adhesive layer by which the reflective polarizing film is integrated with the base film or the optical pattern.

Each of the first adhesive layer 130 and the second adhesive layer 150 may include a resin composition that has excellent transparency and that may form a cross-linked bond suitable for maintaining a shape of an optical structure. For example, Lewis acid or polyethylol-based epoxy, unsaturated polyester-styrene, acrylic or methacrylic (hereinafter, (meth)acrylic) ester resins may be used. Among these resins, a (meth)acrylic ester resin may be used as the resin composition and may exhibit excellent transparency. Examples of the (meth)acrylic ester resin may include oligomers, such as polyurethane(meth)acrylate, epoxy(meth)acrylate, and polyester(meth)acrylate, which may be used alone or in combination with a (meth)acrylate monomer having a multi-functional group or a mono-functional group. The first adhesive layer 130 and the second adhesive layer 150 may have a thickness of about 1 μm to about 30 μm, e.g., about 1 μm to about 10 μm. Within this range, the adhesive layers may help secure sufficient adhesion while minimizing luminance deterioration.

The reflective polarizing film 140 may help minimize light loss while recycling light. The reflective polarizing film 140 may have a multilayer structure and may be fabricated by alternately stacking two types of polymer layers having different indexes of refraction. The reflective polarizing film 140 may selectively reflect or transmit light using a function of separating polarized light components so as to transmit only a light component oscillating in a direction parallel to one transmission axis while reflecting the other light component. For example, the reflective polarizing film may have a structure in which a plurality of polymer layers, which have the same indexes of refraction in an x-axis and different indexes of refraction in a y-axis, are alternately stacked one above another. Here, the x-axis may be a transmittance axis in which the reflective polarizing film can transmit light, and the y-axis may be a reflection axis in which the reflective polarizing film can reflect light. Thus, the reflective polarizing film may transmit p-waves of light components, and reflect s-waves of the light components to continuously recycle the same. One example of the reflective polarizing film may include a Dual Luminance Enhancement Film (DBEF, 3M Co., Ltd.).

The reflective polarizing film 140 may be formed by alternately stacking first polymer layers and second polymer layers one above another. In an implementation, each of the first polymer layers may have a thickness of about 15 μm to about 25 μm and an index of refraction from about 1.45 to about 1.49, and each of the second polymer layers may have a thickness from about 15 μm to about 25 μm and an index of refraction from about 1.51 to about 1.58. The reflective polarizing film 140 may have a total thickness of about 120 μm to about 150 μm.

Each of the first and second base films 111, 121 may have a thickness of, e.g., about 50 μm to about 300 μm.

The first and second base films 111, 121 may be formed of the same materials or different materials. For example, the first and second base films 111, 121 may be formed of a resin having excellent light transmittance, such as polyethylene terephthalate (PET), polycarbonate (PC), triacetyl cellulose (TAC), polymethyl methacrylate (PMMA), polystyrene (PS)-based films, or the like.

In an implementation, the reflective polarizing film 140 may be formed to selectively transmit p-waves, thereby improving efficiency of a light source. Thus, the first or second base film 111 or 121 (directly formed on the reflective polarizing film 140) may be a non-oriented or uniaxially oriented film that may transmit light in the same direction as the direction in which the reflective polarizing film 140 transmits light, in terms of improvement in luminance and visibility.

The first and second optical patterns 112, 122 may be formed from a UV-curable resin composition. The UV-curable resin composition may include a UV-curable compound and a photoinitiator.

The UV-curable compound may be a compound having an acrylate-based functional group and may include, e.g., ethylene glycol diacrylate, neopentyl glycol di(meth)acrylate, 1,6-hexanediol(meth)acrylate, trimethylolpropane tri(meth)acrylate, dipentaerythritol hexa(meth)acrylate, polyol poly(meth)acrylate, di(meth)acrylate of bisphenol A-diglycidyl ether, poly(meth)acrylate obtained by esterification of polyhydric alcohols, polyhydric carboxylic acids, anhydrides thereof, and acrylic acids, polysiloxane polyacrylate, urethane(meth)acrylate, pentaerythritol tetramethacrylate, glycerin trimethacrylate, or urethane acrylate. In an implementation, the UV-curable compound having an acrylate-based functional group may include an acrylate compound having a hydroxyl group. The acrylate compound having a hydroxyl group may include oligomers, such as 2-hydroxyethyl acrylate oligomers, 2-hydroxypropyl acrylate oligomers, and pentaerythritol triacrylate oligomers; and monomers, such as 2-hydroxyethyl(meth)acrylate, 2-hydroxypropyl(meth)acrylate, caprolactone(meth)acrylate, 2,3-dihydroxypropyl(meth)acrylate, and 4-hydroxymethylcyclohexyl(meth)acrylate. In an implementation, the UV-curable compound may be a fluorine-containing compound, e.g., fluorine-containing epoxy acrylate or fluorine-containing alkoxysilane. Examples of the fluorine-containing compound may include 2-(perfluorodecyl)ethyl(meth)acrylate, 3-perfluorooctyl-2-hydroxypropyl(meth)acrylate, 3-(perfluoro-9-methyldecyl)-1,2-epoxypropane, 2,2,2-trifluoroethyl(meth)acrylate, 2-trifluoromethyl(meth)acrylate, and 3,3,3-trifluoropropyl(meth)acrylate.

The photoinitiator may be a suitable photoinitiator. For example, the photoinitiator may include a benzophenone compound, such as 1-hydroxycyclohexyl phenylketone.

The UV-curable resin composition may further include a suitable additive, e.g., a photosensitizer, a photo-desensitizer, a polymerization inhibitor, a leveling agent, a wetting conditioner, a surfactant, a plasticizer, a UV absorber, an antioxidant, an antistatic agent, a silane coupling agent, an inorganic filler, an anti-foaming agent, or the like. These may be used alone or in combination thereof.

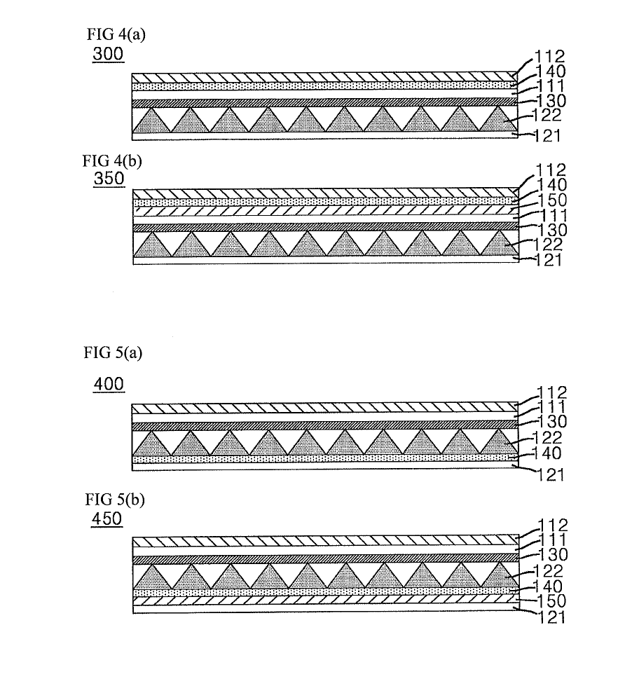

Hereinafter, a composite optical sheet according to a second embodiment will be described in detail with reference to FIGS. 3 and 4.

FIG. 3 illustrates a schematic exploded perspective view of the composite optical sheet according to an embodiment, showing a position in which a reflective polarizing film is formed within the composite optical sheet. FIG. 4(a) illustrates a sectional view of the composite optical sheet 300 according to the second embodiment.

In this embodiment, the reflective polarizing film 140 may be formed within a first optical sheet 110, e.g., at a position P2 between a first base film 111 and a first optical pattern 112.

Hereinafter, a composite optical sheet according to a third embodiment will be described in detail with reference to FIGS. 3 and 5(a). In the composite optical sheet according to the third embodiment, a reflective polarizing film 140 may be formed within a second optical sheet 120, e.g., at a position P3 between a second base film 121 and a second optical pattern 122. FIG. 5(a) illustrates a sectional view of the composite optical sheet 400 according to the third embodiment.

Referring to FIGS. 4(a) and 5(a), the reflective polarizing films 140 according to the second and third embodiments may be formed inside the first and second base films 111, 121, respectively. For example, after a second adhesive layer 150 is formed on the first or second base film 111 or 121, the reflective polarizing film 140 may be formed on the second adhesive layer as shown in the composite optical sheets 350, 450 of FIGS. 4(b) and 5(b). Then, with one surface of the reflective polarizing film 140 adjoining a mold engraving roll, which is engraved with a reverse pattern of the first or second optical pattern 112 or 122, a photo-curable resin composition may be injected into a space between the roll and the reflective polarizing film 140, and cured, followed by separating the cured photo-curable resin composition coating adhered to the reflective polarizing film 140 from the engraving roll, thereby forming the first or second optical pattern 112 or 122. In an implementation, a primer layer (not shown) may be formed on the reflective polarizing film 140 to help improve adhesion, prior to formation of the first or second optical pattern 112 or 122 on the reflective polarizing film 140.

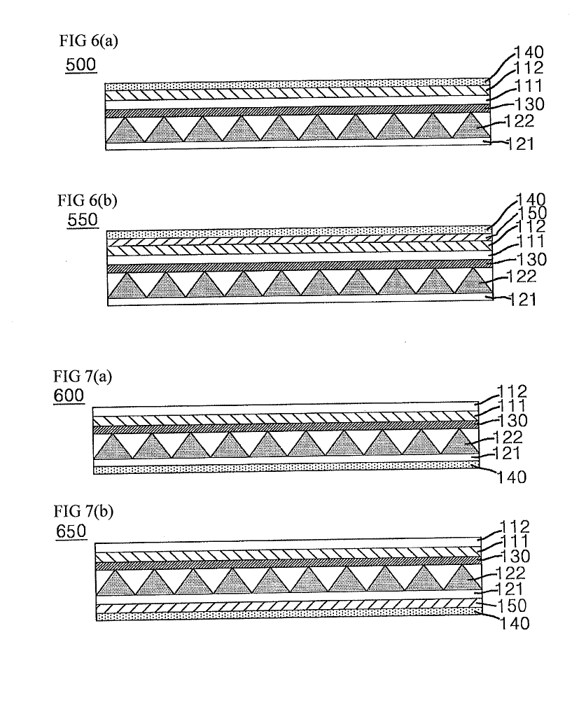

Hereinafter, a composite optical sheet according to a fourth embodiment will be described in detail with reference to FIGS. 3 and 6(a). In the composite optical sheet according to the fourth embodiment, a reflective polarizing film 140 may be formed on a first optical sheet, e.g., at a position P4 on a first optical pattern 112. For example, the reflective polarizing film 140 may be formed on an outer side of the first optical sheet. FIG. 6(a) illustrates a sectional view of the composite optical sheet 500 according to the fourth embodiment. Referring to FIG. 6(b), in a composite optical sheet 550, a second adhesive layer 150 may be formed between the reflective polarizing film 140 and the first optical pattern 112, and thus the first optical pattern 112 and the reflective polarizing film 140 may be integrated with each other by allowing an apex of the first optical pattern 112 to adjoin or penetrate into the second adhesive layer 150.

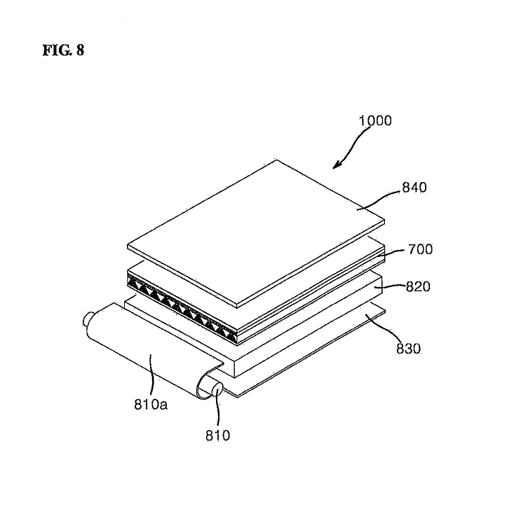

Hereinafter, a composite optical sheet according to a fifth embodiment will be described in detail with reference to FIGS. 3 and 7(a). In the composite optical sheet according to the fifth embodiment, a reflective polarizing film 140 may be formed under a second optical sheet, e.g., at a position P5 under a second base film 121 of the second optical sheet. For example, the reflective polarizing film 140 may be formed on an outer side of the second optical sheet. FIG. 7(a) illustrates a sectional view of the composite optical sheet 600 according to the fifth embodiment. Referring to FIG. 7(b), in a composite optical sheet 650, after a second adhesive film 150 is formed between the second base film 121 and the reflective polarizing film 140, the reflective polarizing film 140 may be formed via the second adhesive layer.

Hereinafter, a backlight unit in accordance with another embodiment will be described in detail with reference to FIG. 8. FIG. 8 illustrates a perspective view of a backlight unit 1000 according to an embodiment.

Referring to FIG. 8, a backlight unit 1000 according to an embodiment may include a light source 810, a light guide plate 820 for guiding light emitted from the light source 810, a reflective sheet 830 below the light guide plate 820 (e.g., at one side thereof), a composite optical sheet 700 above the light guide panel 820 (e.g., at another side thereof), and a protective sheet 840 above the composite optical sheet 700 (e.g., on a side of the composite optical sheet 700 opposite to the light guide plate 820). In an implementation, a light source cover 810a may be disposed outside the light source 810 of the backlight unit 1000. In an implementation, although not shown, a liquid crystal display panel and an anti-reflection layer may be sequentially stacked on the backlight unit 1000, thereby providing a liquid crystal display.

The light source 810 may generate light and may include various light sources, such as line-light lamps, surface-light lamps, CCFLs, or LEDs.

The light guide plate 820 may have a light entrance face (through which light emitted from the light source 810 enters) and a light exit face (perpendicular to the light entrance face), and may guide the light emitted from the light source 810 to the composite optical sheet 700. In an implementation, e.g., when a direct light type light source is used, the light guide plate may be omitted.

The reflective sheet 830 may reflect light emitted from the light source 810 such that the light is directed back towards the composite optical sheet 700.

The composite optical sheet 700 may be formed directly on the light exit face of the light guide plate 820 according an embodiment, and may exhibit excellent luminance without separate diffusive sheets or additional light collecting sheets, while helping to reduce the likelihood of and/or prevent a Moiré phenomenon.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

An optical pattern was formed by regularly arranging hexagonal microlenses (acrylic resin, index of refraction: 1.48), which had a height of 16 μm and a pitch of 40 μm, on a first base film (non-oriented polycarbonate (PC), Toyobo Co., Ltd.) having a thickness of 125 μm, thereby fabricating a first optical sheet. A 26 μm thick reflective polarizing film (APF-V3, 3M Co., Ltd.) was integrated with the first base film via a second adhesive layer (urethane acrylate resin, A-2579, TESK Co., Ltd.) having a thickness of 3 μm under the first base film. Then, a first adhesive layer (urethane acrylate resin, A-2579, TESK Co., Ltd.) having a thickness of 3 μm was formed under the reflective polarizing film.

A second optical sheet was fabricated by forming a prism pattern (acrylic resin, index of refraction: 1.55) on a second base film (non-oriented PC, Toyobo Co., Ltd.) having a thickness of 125 μm. The prism pattern was formed by arranging prisms having a height of 35 μm and a pitch of 70 μm on the second base film. Then, the first optical sheet and the second optical sheet were integrated with each other by disposing the prism apexes of the prism pattern to adjoin the first adhesive layer, thereby preparing a single sheet type composite optical sheet having a structure as shown in FIG. 1.

The prepared composite optical sheet was evaluated as to physical properties. Results are shown in Table 1, below.

### Example 2

A single-sheet type composite optical sheet having a structure as shown in FIG. 1 was prepared in the same manner as in Example 1, except that a polyethylene terephthalate film (biaxially oriented PET, TAK Co., Ltd.) was used as the second base film, and evaluated as to physical properties. Results are shown in Table 1.

### Example 3

A single-sheet type composite optical sheet having a structure as shown in FIG. 1 was prepared in the same manner as in Example 1, except that a polyethylene terephthalate film (biaxially oriented PET, TAK Co., Ltd.) was used as the first base film, and evaluated as to physical properties. Results are shown in Table 1.

### Example 4

A single-sheet type composite optical sheet having a structure as shown in FIG. 1 was prepared in the same manner as in Example 1, except that a polyethylene terephthalate film (biaxially oriented PET, TAK Co., Ltd.) was used as the first and second base film, and evaluated as to physical properties. Results are shown in Table 1.

### Example 5

A first optical pattern was formed by regularly arranging hexagonal microlenses (acrylic resin, index of refraction: 1.48) having a height of 16 μm and a pitch of 40 μm on a first base film (PET, TAK Co., Ltd.) having a thickness of 125 μm, thereby fabricating a first optical sheet. A first adhesive layer (urethane acrylate resin, A-2579, TESK Co., Ltd.) having a thickness of 3 μm was formed under the first optical sheet.

A second adhesive layer (urethane acrylate resin, A-2579, TESK Co., Ltd.) having a thickness of 3 μm was formed on a second base film (non-oriented PC, Toyobo Co., Ltd.) having a thickness of 125 μm, and then a reflective polarizing film (APF-V3, 3M Co., Ltd.) and a prism pattern (acrylic resin, index of refraction: 1.55) were sequentially stacked on the second adhesive layer, thereby fabricating a second optical sheet. The prism pattern was formed by arranging prisms having a height of 35 μm and a pitch of 70 μm on the reflective polarizing film. Then, the first optical sheet and the second optical sheet were integrated with each other by disposing the prism apexes of the prism pattern to adjoin the first adhesive layer, thereby preparing a single-sheet type composite optical sheet having a structure as shown in FIG. 5.

The prepared composite optical sheet was evaluated as to physical properties. Results are shown in Table 1.

### Example 6

A reflective polarizing film (APF-V3, 3M Co., Ltd.) was integrated with a first base film (biaxially oriented PET, TAK Co., Ltd.) having a thickness of 125 μm via a second adhesive layer (urethane acrylate resin, A-2579, TESK Co., Ltd.) having a thickness of 3 μm under the first base film, thereby fabricating a first optical sheet. An optical pattern was formed by regularly arranging hexagonal microlenses (acrylic resin, index of refraction: 1.48) having a height of 16 μm and a pitch of 40 μm on the reflective polarizing film. Then, a first adhesive layer (urethane acrylate resin, A-2579, TESK Co., Ltd.) having a thickness of 3 μm was formed under the first base film.

The second optical sheet was fabricated by forming a prism pattern (acrylic resin, index of refraction: 1.55) on a second base film (biaxially oriented PET, TAK Co., Ltd.) having a thickness of 125 μm. The prism pattern was formed by arranging prisms having a height of 35 μm and a pitch of 70 μm on the second base film. Then, the first optical sheet was integrated with the second optical sheet by disposing the prism apexes of the prism pattern to adjoin the first adhesive layer, thereby preparing a single-sheet type composite optical sheet having a structure as shown in FIG. 4.

The prepared composite optical sheet was evaluated as to physical properties. Results are shown in Table 1.

### Example 7

A first optical pattern was formed by regularly arranging hexagonal microlenses (acrylic resin, index of refraction: 1.48) having a height of 16 μm and a pitch of 40 μm on a first base film (biaxially oriented PET, TAK Co., Ltd.) having a thickness of 125 μM, thereby fabricating a first optical sheet. Then, a first adhesive layer (urethane acrylate resin, A-2579, TESK Co., Ltd.) having a thickness of 3 μm was formed under the first optical sheet.

A prism pattern was formed on a second base film (biaxially oriented PET, TAK Co., Ltd.), thereby fabricating a second optical sheet. The prism pattern was formed by arranging prisms having a height of 35 μm and a pitch of 70 μm on the reflective polarizing film. The reflective polarizing film (APF-V3, 3M Co., Ltd.) was integrated with the second base film via a second adhesive layer (urethane acrylate resin, A-2579, TESK Co., Ltd.) having a thickness of 3 μm under the second base film.

Then, the first optical sheet was integrated with the second optical sheet by disposing the prism apexes of the prism pattern to adjoin the first adhesive layer, thereby preparing a single-sheet type composite optical sheet having a structure as shown in FIG. 7.

The prepared composite optical sheet was evaluated as to physical properties. Results are shown in Table 1.

### Comparative Example 1

An optical pattern was formed by regularly arranging hexagonal microlenses (acrylic resin, index of refraction: 1.48) having a height of 16 μm and a pitch of 40 μm on a first base film (non-oriented PC, Toyobo Co., Ltd.) having a thickness of 125 μm, thereby fabricating a first optical sheet. A second optical sheet was fabricated by forming a prism pattern (acrylic resin, index of refraction: 1.55) on a second base film (non-oriented PC, Toyobo Co., Ltd.) having a thickness of 125 μm. The prism pattern was formed by arranging prisms having a height of 35 μm and a pitch of 70 μm on the second base film.

The prepared double-sheet type composite optical sheet was evaluated as to physical properties. Results are shown in Table 2, below.

### Comparative Example 2

An optical pattern was formed by regularly arranging hexagonal microlenses (acrylic resin, index of refraction: 1.48) having a height of 16 μm and a pitch of 40 μm on a first base film (non-oriented PC, Toyobo Co., Ltd.) having a thickness of 125 μm, thereby fabricating a first optical sheet. A reflective polarizing film (APF-V3, 3M Co., Ltd.) having a thickness of 26 μm was integrated with the first base film via a second adhesive layer (urethane acrylate resin, A-2579, TESK Co., Ltd.) having a thickness of 3 μm under the first base film.

A second optical sheet was fabricated by forming a prism pattern (acrylic resin, index of refraction: 1.55) on a second base film (non-oriented PC, Toyobo Co., Ltd.) having a thickness of 125 μm. The prism pattern was formed by arranging prisms having a height of 35 μm and a pitch of 70 μm on the second base film.

A double-sheet type-composite optical sheet was prepared by stacking the second optical sheet on the first optical sheet, and evaluated as to physical properties. Results are shown in Table 2.

### Comparative Example 3

A double-sheet type-composite optical sheet was prepared in the same manner as in Comparative Example 1, except that a polyethylene terephthalate film (biaxially oriented PET, TAK Co., Ltd.) was used as the second base film, and evaluated as to physical properties. Results are shown in Table 2.

### Comparative Example 4

A double-sheet type-composite optical sheet was prepared in the same manner as in Comparative Example 1, except that a polyethylene terephthalate film (biaxially oriented PET, TAK Co., Ltd.) was used as the first base film, and evaluated as to physical properties. Results are shown in Table 2.

### Comparative Example 5

A double-sheet type-composite optical sheet was prepared in the same manner as in Comparative Example 1, except that a polyethylene terephthalate film (biaxially oriented PET, TAK Co., Ltd.) was used as the first and second base film, and evaluated as to physical properties. Results are shown in Table 2.

Property Evaluation

(1) Luminance: With each of the composite optical sheets prepared in the Examples and Comparative Examples secured to a backlight unit for 32-inch liquid crystal display panels, luminance values at Points No. 13 and 5 were measured using an SR3 luminance photometer (TOPCON Co., Ltd.) and averaged. An LED lamp was used as a light source of the backlight unit. The luminance values are expressed as percent values (%) with respect to luminance of the composite optical sheet prepared in Comparative Example 1.

(2) Warping: Each of the composite optical sheets prepared in the Examples and Comparative Examples was mounted on a backlight unit, left in a constant temperature chamber at 85° C. and 85% RH for 96 hours, and then left at room or ambient temperature for 1 hour, followed by evaluation as to a degree of warping with the naked eye. Observation results were rated from 1 to 10, in which a higher value indicates a higher degree of warping.

(3) Wrinkle: Each of the composite optical sheets prepared in the Examples and Comparative Examples was mounted on a backlight unit, left in a constant temperature chamber at 85° C. and 85% RH for 96 hours, and then left at ambient temperature for 1 hour, followed by evaluation as to a degree of wrinkling with the naked eye. Observation results were rated from 1 to 10, in which a higher value indicates a higher degree of wrinkling.

TABLE 1

| | Example 1 | Example 2 | Example 3 | Example 4 | Example 5 | Example 6 | Example 7 |
|---|---|---|---|---|---|---|---|
| First optical pattern | MLA | MLA | MLA | MLA | MLA | MLA | MLA |
| (1-2) | | | | | | | |
| First base film (1-1) | PC | PC | PET | PET | PET | PET | PET |
| Position of reflective | Under 1-1 | Under 1-1 | Under 1-1 | Under 1-1 | On 2-1 | On 1-1 | Under 2-1 |
| polarizing film | | | | | | | |
| Second optical pattern | prism | prism | Prism | prism | prism | prism | prism |
| (2-2) | | | | | | | |
| Second base film (2-1) | PC | PET | PC | PET | PC | PET | PET |
| Luminance (%) | 121 | 123 | 65 | 67 | 65 | 66 | 64 |
| Warping (1~10) | 1 | 1 | 2 | 2 | 2 | 2 | 2 |
| Wrinkle (1~10) | 1 | 1 | 2 | 2 | 2 | 2 | 2 |

TABLE 2

| | Comparative | Comparative | Comparative | Comparative | Comparative |
|---|---|---|---|---|---|
| | Example 1 | Example 2 | Example 3 | Example 4 | Example 5 |
| First optical pattern (1-2) | MLA | MLA | MLA | MLA | MLA |
| First base film (1-1) | PC | PC | PC | PET | PET |
| Position of reflective | — | Under 1-1 | Under 1-1 | Under 1-1 | Under 1-1 |
| polarizing film | | | | | |
| Second optical pattern (2-2) | prism | prism | prism | prism | prism |
| Second base film (2-1) | PC | PC | PET | PC | PET |
| Luminance (%) | 100 | 128 | 132 | 74 | 76 |
| Warping (1~10) | 4 | 3 | 3 | 5 | 5 |
| Wrinkle (1~10) | 4 | 3 | 5 | 3 | 5 |

As may be seen in Table 1 and 2, the single-sheet type composite optical sheets of Examples 1 to 7, in which each included the reflective polarizing film and in which the first optical sheet was integrated with the second optical sheet via the first adhesive layer, had a lower degree of warping or wrinkling, thereby exhibiting excellent dimensional stability and reliability, as compared with the double-sheet type composite optical sheets of Comparative Examples 1 to 5, in which the first optical sheet was not integrated with the second optical sheet. For example, the composite optical sheets of Examples 1 to 4, in which the first optical sheet was integrated with the second optical sheet via the first adhesive layer with the reflective polarizing film integrated therewith, exhibited further improved properties in terms of luminance, dimensional stability and reliability, as compared with the composite optical sheets of the Comparative Examples, which were fabricated without using the reflective polarizing film.

By way of summation and review, liquid crystal displays may require high luminance, wide viewing angle, low energy consumption, small thickness, and light weight. For example, the liquid crystal displays may require high luminance.

An improvement in luminance may be obtained by increasing luminance of a light source or by improving utilization of light. Improvement in luminance of the light source may increase energy consumption, and improvement in utilization of light may achieve high luminance without undesirably increasing energy consumption. In order to achieve an improvement in luminance without increase in energy consumption, a stack of light collecting sheets may be used as in a prism-on-prism (POP) structure, or a combination of light collecting sheets and diffusive sheets may be used, as in a microlens-on-prism (MOP) structure.

With the trend of slimness of display panels, thickness of an optical sheet may be minimized. For this purpose, a plurality of optical sheets integrated with each other may be used. Efficient use of a light source and improvement in luminance may be considered.

The embodiments may provide a composite optical sheet that provides excellent luminance.

The embodiments may provide a composite optical sheet exhibiting excellent dimensional stability.

The embodiments may provide a composite optical sheet exhibiting excellent reliability.

According to an embodiment, the composite optical sheet may include a reflective polarizing film, thereby providing excellent luminance. In addition, the composite optical sheet may have an integral structure of a single sheet to have a low degree of warping, thereby providing excellent dimensional stability and reliability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composite optical sheet, comprising:
a first optical sheet that includes a first optical pattern;
a second optical sheet that includes a second optical pattern;
a first adhesive layer between the first optical sheet and the second optical sheet; and
a reflective polarizing film,
wherein:
the second optical pattern is adhered to the first adhesive layer,
the reflective polarizing film has a plurality of polymer layers that have different indexes of refraction, the plurality of polymer layers being alternately stacked one above another, and
the reflective polarizing film is integrated with the first optical sheet, the second optical sheet, or the first adhesive layer.

2. The composite optical sheet as claimed in claim 1, wherein:
the first optical sheet includes a first base film and the first optical pattern,
the reflective polarizing film is between the first adhesive layer and the first base film, and
the first base film and the reflective polarizing film are integrated with each other via a second adhesive layer.

3. The composite optical sheet as claimed in claim 2, wherein the first base film includes a non-oriented or uniaxially oriented polycarbonate film or a non-oriented or uniaxially oriented polyethylene terephthalate film.

4. The composite optical sheet as claimed in claim 1, wherein:
the first optical sheet includes a first base film and the first optical pattern,
the reflective polarizing film is between the first base film and the first optical pattern, and
the first base film and the reflective polarizing film are integrated with each other via a second adhesive layer.

5. The composite optical sheet as claimed in claim 1, wherein:
the second optical sheet includes a second base film and the second optical pattern,
the reflective polarizing film is between the second base film and the second optical pattern, and
the second base film and the reflective polarizing film are integrated with each other via a second adhesive layer.

6. The composite optical sheet as claimed in claim 1, wherein:
the second optical sheet includes a second base film and the second optical pattern,
the reflective polarizing film is under the second base film, and
the second base film and the reflective polarizing film are integrated with each other via a second adhesive layer.

7. The composite optical sheet as claimed in claim 5, wherein the second base film includes a non-oriented or uniaxially oriented polycarbonate film or a non-oriented or uniaxially oriented polyethylene terephthalate film.

8. The composite optical sheet as claimed in claim 1, wherein:
the reflective polarizing film is on the first optical pattern, and
the first optical pattern and the reflective polarizing film are integrated with each other via a second adhesive layer.

9. The composite optical sheet as claimed in claim 1, wherein:
the reflective polarizing film includes first and second polymer layers alternately stacked one above another,
the first polymer layer has a thickness of about 15 μm to about 25 μm and an index of refraction of about 1.45 to about 1.49, and
the second polymer layer has a thickness of about 15 μm to about 25 μm and an index of refraction of about 1.51 to about 1.58.

10. The composite optical sheet as claimed in claim 1, wherein the first and second optical patterns each independently include patterns selected from the group of a microlens pattern, a hexagonal microlens pattern, an embossed pattern, a lenticular lens pattern, a prism pattern, a pyramidal pattern, and combinations thereof.

11. The composite optical sheet as claimed in claim 10, wherein:
at least one of the first optical pattern and the second optical pattern include the prism pattern, and
the prism pattern includes a plurality of prisms, apexes of which adjoin or penetrate the first adhesive layer.

12. The composite optical sheet as claimed in claim 11, wherein the prisms have a height of about 10 μm to about 50 μm and a pitch of about 20 μm to about 100 μm.

13. The composite optical sheet as claimed in claim 1, wherein the first optical pattern and the second optical pattern are prism patterns.

14. The composite optical sheet as claimed in claim 1, wherein the first optical pattern is a lenticular lens pattern and the second optical pattern is a prism pattern.

15. The composite optical sheet as claimed in claim 1, wherein:
the first optical sheet has a thickness of about 50 μm to about 300 μm,
the second optical sheet has a thickness of about 50 μm to about 300 μm,
the first adhesive layer has a thickness of about 1 μm to about 30 μm, and
the reflective polarizing film has a thickness of about 120 μm to about 150 μm.

16. A backlight unit comprising the composite optical sheet as claimed in claim 1.
